(19) United States
(12) Patent Application Publication
(10) Pub. No.: US 2012/0227669 A1
(43) Pub. Date: Sep. 13, 2012

(54) Animal Feed Lick

(76) Inventors: Harry Ray, Waynesboro, PA (US); Gary Dudderar, Blue Ridge Summit, PA (US)

(21) Appl. No.: 13/043,679

(22) Filed: Mar. 9, 2011

(51) Int. Cl. A01K 5/00

(52) U.S. Cl. 119/51.03

(57) ABSTRACT

A feed block for attracting game comprising: mixture of grain, corn syrups and sugar, where said mixture is formed into a block; and at least two holes through the block, where the holes provide a means to place the block in a stationary position. The feed block may be suspended with a rope, string or cord by inserting the rope, string or cord through the at least two holes. In one exemplary embodiment, the block is mounted onto a stationary object in an elevated position by using a mounting means. The mounting means may include a bolt, spike or screw and the stationary object may include a tree.

### BACKGROUND OF THE INVENTION

1. Field of Invention

The present invention relates to a feeding block that is used to attract animals for hunting purposes.

2. Description of Related Art

Hunting is a recreational sport enjoyed by many individuals. Most recreational hunters practice hunting during the hunting season designated by their particular state. Hunting involves the tracking, stalking and killing of animals for sport and/or food. Hunters pursue various types of game such as a small game such as squirrels, rabbits or other small varmints. Some hunters pursue fowl and other hunters pursue larger game such as deer, moose or bears to name a few.

Hunters use various techniques to attract and lure animals into suitable positions for hunting purposes. The advantage of using lures and scenting devices is that the animals are attracted to a particular area where the hunters may lay hidden in order to successfully capture the animals. Some particular products include animal calls calls such as deer calls or scented blocks (licks). Some of the drawbacks to using the traditional feed block are that some of the blocks may not have suitable taste to actually attract the particular game. Further the blocks may not have a suitable scent so that they attract the game that is being hunted. Many times the feed blocks are normally placed on the ground and therefore the block itself may be absorbed into the ground over a period of time and also the scent would be limited in its travel due to the positioning of the block. Consequently, it would be advantageous to have a feed block that may be mounted or secured in an elevated position thereby providing a more advantageous position to disperse the scent that is associated with the block.

### SUMMARY OF THE INVENTION

The present invention relates to a feed block for attracting game comprising: mixture of grain, corn syrups and sugar, where said mixture is formed into a block; and at least two holes through the block, where the holes provide a means to place the block in a stationary position. The feed block may be suspended with a rope, string or cord by inserting the rope, string or cord through the at least two holes. In one exemplary embodiment, the block is mounted onto a stationary object in an elevated position by using a mounting means. The mounting means may includes a bolt, spike or screw and the stationary object may include a tree.

### BRIEF DESCRIPTION OF DRAWINGS

FIG. 1 depicts an animal feed block according to the present invention.

FIGS. 2A, 2B, 2C and 2D depict various applications of the feed block according to the present invention.

### DETAILED DESCRIPTION

The present invention relates to a feed block that is used to attract and lure game into a particular area for hunting purposes. The feed block according to the present invention is a singular block that is manufactured with a combination of grain, corn syrups and sugar, which provides a suitable mixture for attraction of wild game. The mixture is formed into a log or a block form in a rectangular square shape. The block includes a means to mount and affix the block to a stationary position so that the block may be elevated above the ground or actually set in a stable position in the ground if desired.

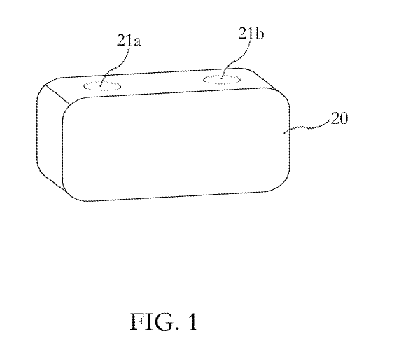

In reference to FIG. 1, a feed block 20 according to the present invention is depicted. The feed block is a special blend of grain, syrup and flavoring that is cooked, mixed and sealed in a block form as shown in FIG. 1. The feed block 20 includes at least two holes 21a, 21b that provide a means to mount the block onto a stationary object or actually hang the block from a tree. Once in position the feed block 20 according to present invention includes a suitable scent that will attract and lure animals and a pleasing taste that also will allow animals to linger and actually lick on the block.

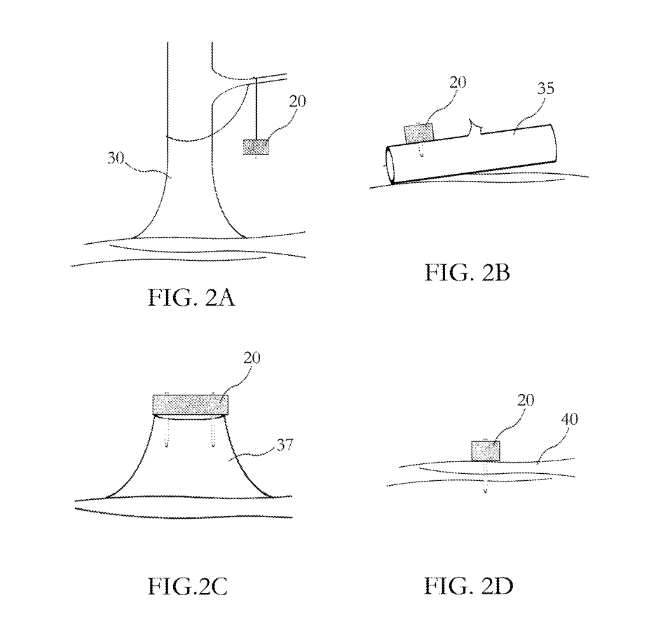

Various applications of the feed block 20 are depicted in FIGS. 2A, 2B, 2C and 2D. In reference to FIG. 2A, the feed block 20 is shown hanging from a tree 30. Alternatively the feed block 20 may be mounted, spiked or screwed into a tree 35 that is on the ground as shown in FIG. 2B. The feed block 20 may also be mounted or screwed into a tree stump 37 as shown in FIG. 2C. Yet another alternative application is actually mounting the feed block 20 into the ground 40 itself as depicted in FIG. 2D. The applications of feed block in accordance with the present invention are shown in the figures for exemplary purposes, however the block may be easily mounted on any stationary object or hung over any other stationary objects within the woods or other hunting areas.

The feed block according to present invention therefore increases the application of a feed block and allows for the feed block to be elevated as opposed to the traditional feed block, which is placed on the ground. The feed block according to the present invention therefore allows hunters to attract animals for several days and avoids any dissolving that is associated with placing feed blocks on the ground that is often the case with feed blocks of the prior part. Further the mixture provided by the present invention attracts a wide range of wildlife such as deer, bear, squirrels or raccoons. The instant invention has been shown and described in what it considers to be the most practical and preferred embodiments. It is recognized, however, that departures may be made there from within the scope of the invention and that obvious modifications will occur to a person skilled in the art.

What is claimed is:

1. A feed block for attracting game comprising:
a. mixture of grain, corn syrups and sugar, where said mixture is formed into a block; and
b. at least two holes through the block, where the holes provide a means to place the block in a stationary position.

2. The feed block according to claim 1, where said block is suspended with a rope, string or cord by inserting the rope, string or cord through the at least two holes.

3. The feed block according to claim 1, where said block is mounted onto a stationary object in an elevated position by using a mounting means.

4. The feed block according to claim 3, where the mounting means includes a bolt, spike or screw.

5. The feed block according to claim 3, where the stationary object is a tree.
